(19) United States
(12) Patent Application Publication
(10) Pub. No.: US 2013/0215990 A1
(43) Pub. Date: Aug. 22, 2013

(54) Multiple-Mode Digital Modulation Using a Single Square-Root Nyquist Pulse-Shaping Transmit Filter

(71) Applicant: Vecima Networks Inc., (US)

(72) Inventors: Nikolaj Larionov, Victoria (CA); Michael A. Jaspar, Saskatoon (CA)

(73) Assignee: VECIMA NETWORKS INC., Victoria (CA)

(21) Appl. No.: 13/755,440

(22) Filed: Jan. 31, 2013

Related U.S. Application Data
(60) Provisional application No. 61/600,001, filed on Feb. 17, 2012.

(51) Int. Cl. H04L 25/03

(52) U.S. Cl. CPC H04L 25/03159
USPC 375/285

(57) ABSTRACT

In a method of digital communication where the transmitter includes a pulse-shaping filter and the receiver includes a plurality of corresponding matched filters, the pulse shaping filter is approximated to match a plurality of filters of the receiver for reducing the number of transmit shaping filters. The filter comprises a square-root raised cosine (SRRC) filter where the SRRC filter amplitude/phase response is approximated using a typical Parks-McClellan (remez) algorithm for designing linear phase FIR filters which, for a given set of input parameters, outputs a transmit filter coefficient set for the SRRC filter. The input parameters to the Parks-McClellan algorithm are chosen by iteration such that pass-band ripple, 3-dB point, and stop-band attenuation of the transmit filter meet or exceed specification requirements while the resulting transmit-receive filter pair ISI is minimized across a plurality of matched filter specifications.

This application claims the benefit under 35 USC 119 (e) of Provisional application 61/600,001 filed Feb. 17, 2012.

This invention relates in general to digital communications and more specifically to digital modulation methods which employ square-root raised cosine (SRRC) transmit pulse-shaping filters. This invention allows the use of a single fixed transmit pulse-shaping filter in place of a typical arrangement of multiple filters to simultaneously meet the functional, performance and filter shape requirements of a digital modulation scheme.

### BACKGROUND OF THE INVENTION

Current digital communication systems operate using band limited modulated channels. In the field of cable television (CATV) networks, the predominant modulation scheme is quadrature amplitude modulation (QAM), as defined in ITU-T Recommendation J.83. The J.83 standard defines a number of Annexes, each of which details slightly different QAM parameters to suit the specific needs of the countries in which the CATV equipment is used.

J.83 dictates the use of a square-root raised cosine (SRRC) for channel pulse-shaping. Within a standard digital implementation of a J.83 QAM modulator, for example, the filter is implemented as a series of coefficients representing the impulse response of the filter. The series of coefficients and a wide-band input data stream are convolved to produce a filtered band-limited output data stream ready for transmission.

In order to have an optimal receiver from the perspective of channel noise and inter-symbol interference (ISI), it is common to have a pair of identical square-root raised-cosine (SRRC) filters, one at each of the transmitter (pulse-shaping filter) and receiver (matching filter) such that their cascade response is the raised cosine (RC) filter that is known to be an optimal and finite approximation of an infinite ideal filter.

The SRRC filters are usually standardized by defining a template for the amplitude characteristics of the channel shape. The template specifies ripples in the filter pass-band and at the Nyquist frequency, a ˜3 dB point as well as the out-of-band rejection. The ˜3 dB point of SRRC frequency response is an important characteristic that is related to the half symbol rate. The SRRC filter frequency response (‘H(f)’) theoretical function is defined by the following equation:

pass band: H(f)=1 for |f|<=fn(1−r)

transition band: H(f)=sqrt{0.5+0.5*sin(Pi/2fn[(fn−|f|)/r])}for fn(1−r)<=|f|<=fn(1+r)

stop band: H(f)=0 for |f|>fn(1r) (1)

where ‘sqrt’ means square root operation, ‘f’ is frequency, ‘r’ is the roll-off factor and ‘fn’ is the Nyquist frequency equal to half the symbol rate ‘Rs’.

Therefore the baseband bandwidth (‘B’) is equal to:

B=(1+r)fn. or B=(1+r)Rs/2 (2)

One of the characteristics of an ideal filter is that its impulse response (‘h(mT)’) is equal to zero at any symbol time intervals ‘mT’ except for the center one, i.e.

h(mT)=1 when m=0

h(mT)=0 when m=+/−1,+/−2,+/−3 (3)

where T is the time between symbol transmissions related to the symbol rate of a particular standard. Equation (3) shows that there should be no ISI between different symbols coming at symbol rate. A practically implemented SRRC filter is close to satisfying equation (3), however its ISI is never equal to zero due to the finite filter length.

Symbol rate, channel bandwidth, SRRC roll-off factor and out-of-band spectral emission mask are unique parameters for each of the modulation orders defined in the J.83 Annexes.

The use of the exact same SRRC filter at both the transmitter and receiver minimizes ISI. If on the other hand, the SRRC filter at the transmitter is designed for different specifications (i.e. rate, roll-off factor and bandwidth) than the matching SRRC filter at the receiver, ISI is increased and can significantly degrade the performance of the receiver.

To meet the need for a growing number of high definition video channels and continuously increasing data services to customers, modern CATV systems utilize large numbers of QAM modulators within any one particular coaxial network serving a group of subscribers (“service group”). 10 s to >100 QAM channels are required per service group with a single QAM modulator device (for example, a Converged Cable Access Platform (CCAP) defined by CableLabs in their CCAP Technical Report) serving 10 s of service groups. The density, cost and power consumption targets of cable operators for a CCAP device require optimizations in all areas of the design. Since hardware for devices like CCAP are designed to support all of the modes defined in the J.83 Annexes, there is benefit to being able to utilize a common fixed transmit pulse-shaping filter to meet the disparate requirements of the various J.83 modes.

The following references may be relevant to this matter and may provide additional relevant disclosure which is incorporated herein by reference:

(1) ITU-T Recommendation J.83

(2) CableLabs CCAP Technical Report
www.cablelabs.com/specifications/CM-TR-CCAP-V03-120511.pdf

(3) CableLabs Downstream Radio Frequency Interface Specification
www.cablelabs.com/.../CM-SP-DRFI-I12-111117.pdf

(4) “An Improved Square-Root Nyquist Shaping Filter” by fred harris et al, SDR Forum 2005

### SUMMARY OF THE INVENTION

It is one object of the invention to provide a method to define and enable the use of a single filter as the transmit filter for more than one digital modulation scheme and/or international standards for digital communication.

According to the invention there is provided a method of digital communication comprising:

providing in a transmitter a pulse-shaping filter;

providing in a receiver a plurality of corresponding matched filters;

wherein each pulse-shaping filter comprises a raised-cosine (RC) or square-root raised cosine (SRRC) filter;

and wherein the pulse-shaping filter of the transmitter has a frequency response which is approximated so as to match, within the required standards, a plurality of the matched filters of the receiver.

Preferably the algorithm provides an iterative search for the approximation parameters and is considered completed when the ISI for all applicable standards is approximately at the same level while all pass-band ripple, 3 dB, and stop-band requirements are met.

For example, the SRRC filter amplitude/phase response defined in Equation (1) can be approximated using a typical Parks-McClellan algorithm for linear phase FIR filters which, for a given set of input parameters, outputs a transmit filter coefficient set. Other algorithms can also be used. The Parks-McClellan algorithm attempts to minimize the maximum error between the desired response and the actual frequency response. Other examples include the well-known least-mean-square approach which may be used to similar effect.

The input parameters to the algorithm are chosen such that the frequency response of a single coefficient set meets or exceeds the functional and performance requirements of one or more modulation schemes and/or international standards:

general transmit filter shape (i.e. RC or SRRC) including:
pass-band ripple
3 dB point
stop-band attenuation and adjacent channel performance

a minimum modulation-error ratio (MER), relating to ISI performance of the transmit-receive filter pair

The selection process for the input parameters is iterative. A selection algorithm varies each of the input parameters while evaluating the output frequency response against the above functional and performance requirements.

In order for one output frequency response to satisfy one or more schemes or standards, the pass-band ripple, 3-dB point, and stop-band attenuation of the transmit filter must meet or exceed the requirements while the MER and ISI performance of the one transmit filter cascaded individually with the ideal receive filter of each desired scheme or standard must exceed the minimum performance of each standard.

The method allows for the use of one transmit filter frequency response to satisfy more than one mode of operation which results in a significant reduction in system complexity and some reduction in component power and cost. These, in part, make an increase in QAM transmission density per system possible.

### BRIEF DESCRIPTION OF THE DRAWINGS

FIG. 1 is a schematic showing a digital communication system according to the present invention including a single pulse-shaping filter for the transmitter which cooperates with a plurality of corresponding matched filters at the receiver.

FIG. 2 is a conventional ITU-T J.83 template for a Square-Root Raised-Cosine Transmit Filter.

FIG. 3 is diagram showing first, second, and third-adjacent channel frequency bands first for a 6 MHz channel plan, and in brackets for an 8 MHz channel plan.

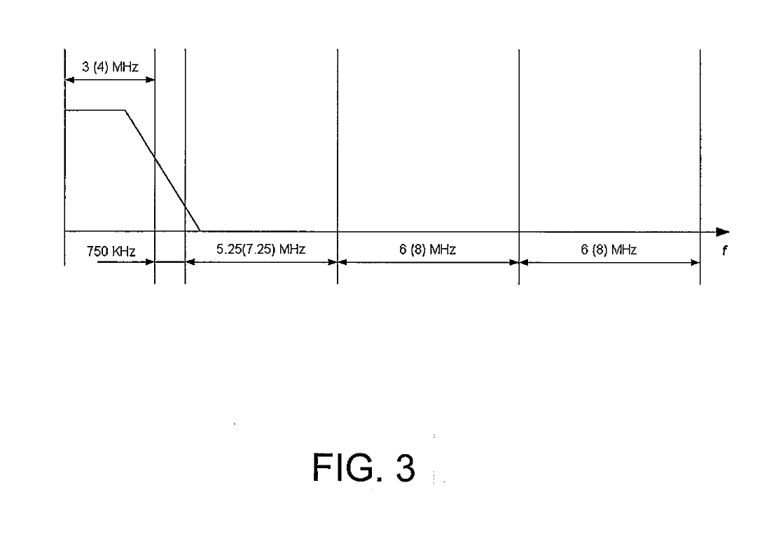

FIG. 4 is a graph showing standard filter responses in comparison with the responses of the single optimized filter of the present invention. The axes are set to focus on the pass-band and 3-dB point requirements.

FIG. 5 is a graph showing standard filter responses in comparison with the responses of the single optimized filter of the present invention. The axes are set to focus on the stop-band attenuation requirements.

FIG. 6 is a graph showing the impulse response (normalized filter coefficients) of an implementation of the single optimized filter of the present invention.

### DETAILED DESCRIPTION

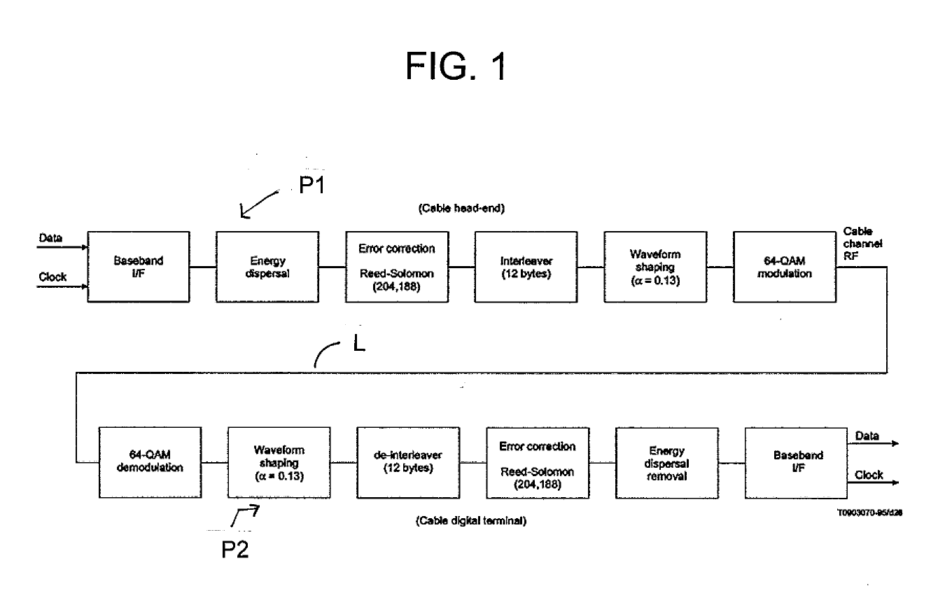

In FIG. 1 is shown a digital communication system as specified in ITU-T J.83 Annex C, using a transmit/receive filter pair of the type used and described herein. The top block labeled ‘waveform shaping’ represents the transmit filter while the lower block labeled same represents the matching or receive filter. The character ‘alpha’ in parentheses represents the specified roll-off factor of the transmit and receive filters. The upper path P1 of the diagram represents the last stage of data processing prior to transmission while the lower path P2 of the diagram represents the first stage of data recovery at the receiver. The line L connecting the upper and lower paths of the figure represents the transmission channel or medium between the transmitter and receiver.

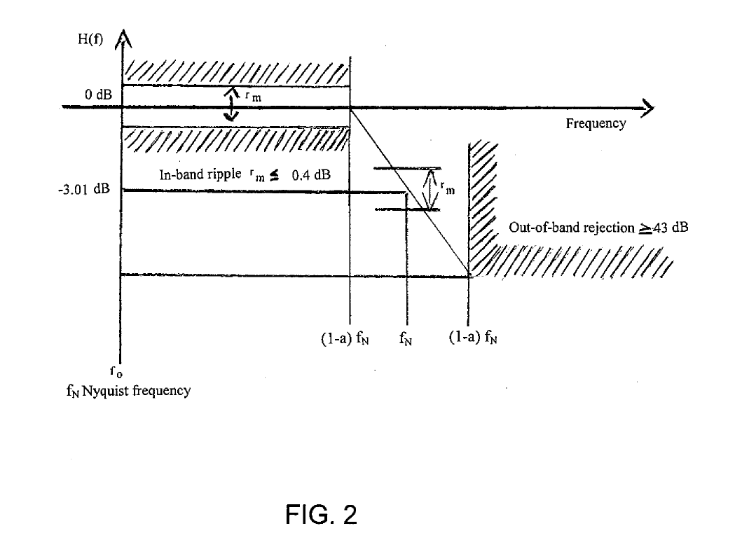

FIG. 2 is the ITU-T J.83 template for a Square-Root Raised-Cosine Transmit Filter. It specifies requirements for a square-root raised-cosine filter having a roll-off factor of ‘alpha’, with pass-band ripple of less than 0.4 dB peak-to-peak, a 3 dB point accuracy of 0.4 dB, and out-of-band rejection of better than 43 dB relative to the nominal pass-band. The use of these specifications allows a designer to specify a set of transmit filter coefficients that meet the requirements of the digital communication system specified by ITU-T J.83.

It is well known that having the exact same SRRC filters at the transmitter and receiver minimizes ISI in the received signal. If, on the other hand, the SRRC filter at the transmitter is designed for different specifications (i.e. rate, roll-off factor and bandwidth) than the matching SRRC filter at the receiver, then ISI is increased and significantly degrades the performance of the received signal. The method of the present invention allows a single filter to be used at the transmitter supporting different filter specifications in the receiver with low resulting ISI that ensures good performance with reduced transmitter complexity.

Selection of the single filter depends on optimization and trade-off between the specification parameters:

Pass-band ripple

3 dB point

Stop-band attenuation and adjacent channel noise power

MER and ISI

Instead of using equation (1) for developing a SRRC shaping filter it is possible to approximate its frequency response using a suitable algorithm such as the well-known Parks-McClellan algorithm that is implemented in several commercially available programs e.g. the ‘remez’ function of Matlab by The Mathworks. The remez function outputs coefficients which minimize the maximum error between the desired and actual frequency responses by defining three sets of parameters:

frequency range (f),

gain in each band (g), and

weight (w).

The most important characteristic of the SRRC frequency response is the ˜3 dB (˜6 dB Nyquist) frequency that is equal to half the symbol rate. At this point the SRRC gain is specified to be square root (sqrt) of 0.5 because combination of transmit and receive filters must have a combined gain equal to 0.5 at half the symbol rate. The pass-band and stop-band of the filter response depend on the roll-off factor ‘r’ in equation (1). Therefore, similar to (1):

f=[0 Beta1(1−r)/N1/N1/N Beta2(1+r)/N2]/2

g=[1.01.0 sqrt(2)/2 sqrt(2)/200] (6)

w=[abc],

where, ‘N’ is equal to half the number of samples per symbol, ‘r’ is the roll-off factor, ‘Beta1’ and ‘Beta2’ are scalers for the transition band, while ‘a’, ‘b’ and ‘c’ are the weights in bands.

The method herein involves iterative modification of the above parameters while evaluating the resulting pass-band ripple, 3 db point, stop-band attenuation and ISI. For various iterations, the 3 dB point remains approximately static so long as the parameter ‘N’ is static. ‘Beta1’ and ‘Beta2’, and the weights ‘a’ ‘b’ and ‘c’ are the primary variables under consideration and affect the transition band, between filter pass-band and filter stop-band of the frequency response. Manipulation of the transition band slightly modifies the approximate roll-off factor of the resulting frequency response. This directly affects both the resulting ISI and the stop-band attenuation. Favorable stop-band attenuation and adjacent noise power are achieved by manipulating the beta and weight parameters while evaluating ISI against all applicable standards of operation in terms of receive filter characteristics. The iterative search for the approximation parameters is considered completed when the ISI for all applicable standards is acceptable and approximately at the same level while all pass-band, 3 dB, and stop-band requirements are met.

The estimation of pass-band ripple is performed by comparing the maximum and minimum frequency response magnitudes in the pass-band region against the required tolerances.

The estimation of the 3 dB point is performed by comparing the average magnitude of the frequency response (the ‘magnitude response’) in the pass-band region with the frequency at which the transition band of the magnitude response is 3 dB lower. That frequency should approximately equal the nominal symbol rate for the channel specification. Deviation from the exact frequency specification increases ISI.

The estimation of stop-band attenuation and adjacent channel noise performance involves an integrated power measurement. In order to do that, an estimate is made of an integrated power of the magnitude response within each adjacent frequency band of interest. The integrated power in each band is estimated as follows:

10 log(Σ[magnitude]̂2)−channel, for f<|fband| (5)

channel=10 log(2*Σ[pass-band magnitude]̂2)

where ‘channel’ is the integrated power of the pass-band, ‘fband’ is the frequency range of the side bands, Σ is the summation operation and logarithm is base 10.

The estimation of ISI is performed using convolution between impulse response of the shaping filter of the transmitter and a corresponding matched filter of the receiver at the symbol rate 1/T, where T is a symbol time interval. As shown in equation (3), when both impulse responses are ideal infinite SRRC filters then only the center of the impulse response is non-zero while estimates at all the remaining T intervals are equal to zero. Considering that actual SRRC filter is truncated to a finite length, the ISI at the non-center T intervals is no longer zero and can be estimated using the following equation:

Σ[Ê2]−Emax̂2/Emax̂2 (4)

where Σ means summation, E is the convolution value between shaping and matched SRRC filters (developed using equation (1)) at each T interval for the length of the impulse response and Emax is the maximum estimate that is actually the center of the impulse response.

Although the design targeted J.83 Annex modes A, B and C [reference 1], the approach can be used in other similar standards.

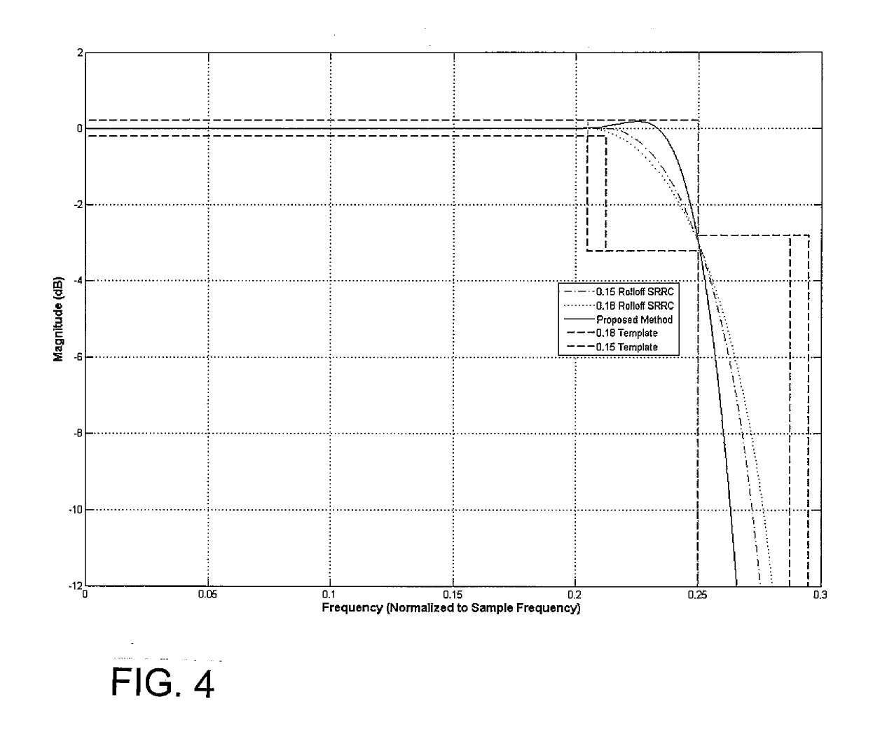

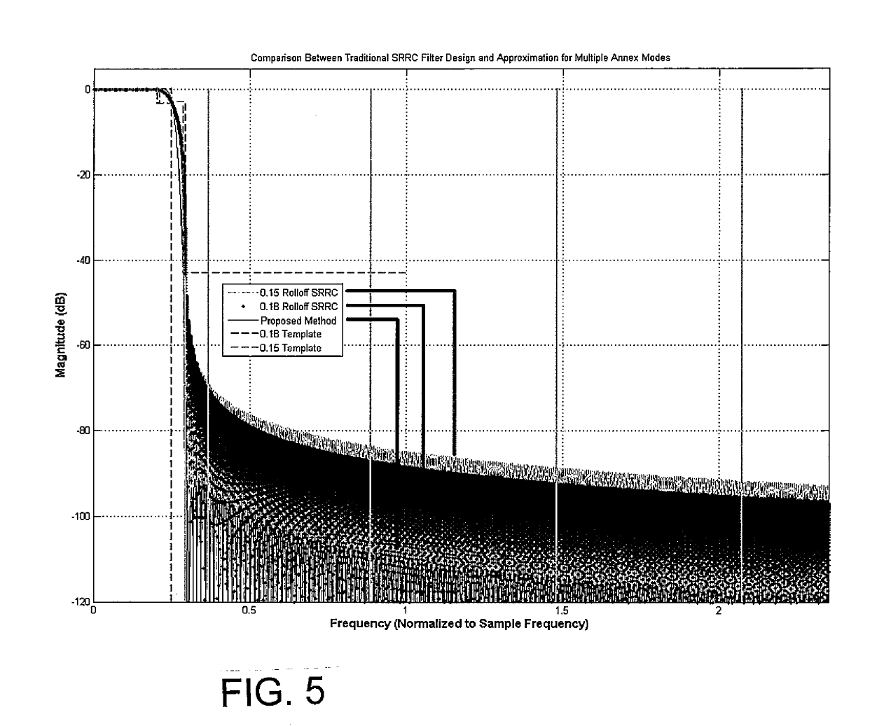

FIGS. 4 and 5 are graphs showing standard filter responses in comparison with the responses of the single optimized filter of the present invention. The dashed traces show typical implementations of two different transmit filters and their specification templates, here ITU-T J.83 Annex A and Annex B, 64 QAM. The solid trace is the optimized filter frequency response showing both the approximated roll-off and transition band still passing through the correct −3 dB point (FIG. 4) and the stop band attenuation exceeding the performance requirement of both typical implementations (FIG. 5). All three filters were of the same order.

One example of an arrangement according to the present invention is described as follows:

The ITU-T J.83 standard specifies several different modes for data transmission over cable. These are summarized in Table 1.

TABLE 1
Channel Specifications in different Annex modes of J.83

| Annex | QAM | Bandwidth | Symbol Rate | Roll-off factor |
|---|---|---|---|---|
| mode | constellation | (MHz) | (MHz) | (r) |
| A | 64/256 | 8 | 6.952 | ~0.15 |
| B | 64 | 6 | 5.056941 | ~0.18 |
| B | 256 | 6 | 5.360537 | ~0.12 |
| C | 64/256 | 6 | 5.274 | ~0.13 |

In addition to ITU-T J.83, the output channel characteristics are defined in DOCSIS (Data-Over-Cable Services Interface Specifications) DRFI (Downstream RF Interface Specification). One of performance requirements of DRFI specification is the adjacent channel noise power (ACP) level defined in dBc. The following Table 2 provides the DRFI specifications for adjacent channel noise in presence of a single channel.

In developing a shaping filter, it is important to match the specified bandwidth, rate and the template of SRRC filter defined in ITU-T J.83 standard for different Annex modes as well as performance requirements given in the DRFI specification.

TABLE 2
DRFI adjacent channel noise requirements for a single channel

| | Bandwidth | | | |
|---|---|---|---|---|
| | 750 KHz | 750 KHz-to-6 MHz | 6-to-12 MHz | 12-to-18 MHz |
| | band | band | band | band |
| 6 MHz | <-58 dBc | <-62 dBc | <-65 dBc | <-73 dBc |
| | Bandwidth | | | |
| | 750 KHz | 750 KHz-to-8 MHz | 8-to-16 MHz | 16-to-24 MHz |
| | band | band | band | band |
| 8 MHz | <-58 dBc | <-60.5 dBc | <-63.5 dBc | <-71.5 dBc |

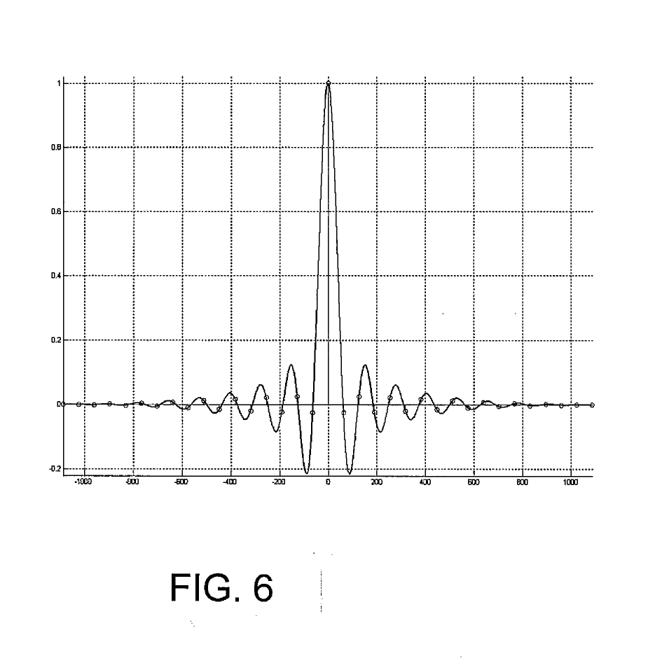

FIG. 6 illustrates the normalized impulse response of the remez-approximated SRRC filter where symbol rate time intervals T are shown with circles.

The following Table 3 lists the parameters for an optimized single transmit filter that has the impulse response shown in FIG. 6. The input roll-off parameter here is specified to approximate SRRC filter with roll-off factor of 0.18. Iterative selection of ‘Betas’ and weights resulted in an approximate SRRC response which provided similarly low ISI for any Annex mode A, B or C.

In accordance with reference (4) above, it is also necessary to modify the very first and last coefficients of the approximated filter in order to have a non-equiripple response. The edge coefficient scaler was selected to scale these coefficients. The major trade-off in selecting the scaler is between the speed of the sidelobe attenuation and ripple in the pass-band. A lower pass-band ripple results lower ISI and higher MER. The scaler was selected to make filter frequency response satisfy J.83 template and DRFI specification in any Annex mode.

TABLE 3
Annex-agile SRRC parameters

| | | | | | | | | Edge |
|---|---|---|---|---|---|---|---|---|
| Length in | | | | | | | | co- |
| symbols, | Samples/ | Roll- | Beta | Beta | | | | efficient |
| N | symbol | off, r | 1 | 2 | a | b | c | scaler |
| 35 | 64 | 0.18 | 1.03 | 0.97 | 2.4535 | 1 | 1.1 | 0.0025 |

The hardware measurements of an implementation of the optimized single SRRC filter were performed using Agilent Power Spectrum Analyzers (PSA) and Vector Signal Analyzer (VSA). Adjacent-channel noise performance exceeded the DRFI specification requirement in all cases. Demodulated non-equalized MER, as a measure of achieved ISI, was equal to ˜42-46 dB across the various J.83 modes. For comparison, non-equalized MER is specified in DRFI as a minimum of 35 dB.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method of digital communication comprising:
providing in a transmitter a pulse-shaping filter;
providing in a receiver a plurality of corresponding matched filters;
wherein each pulse-shaping filter comprises a raised-cosine (RC) or square-root raised cosine (SRRC) filter;
and wherein the pulse-shaping filter of the transmitter has a frequency response which is approximated so as to match, within the required standards, a plurality of the matched filters of the receiver.

2. The method of claim 1 wherein the coefficient set is chosen such that the approximated transmit filter frequency response meets or exceeds the following requirements of one or more standards:
general transmit filter shape (i.e. RC or SRRC) including:
pass-band ripple
3 dB point
stop-band attenuation and adjacent channel noise performance.
a minimum modulation-error ratio (MER), relating to ISI performance of the transmit-receive filter pair.

3. The method of claim 1 wherein the approximations of the frequency response are chosen such that MER and ISI performance of the transmit filter cascaded individually with the ideal receive filter of each desired scheme or standard exceeds the minimum performance of each standard.

4. The method of claim 1 wherein the algorithm provides an iterative search for the approximation parameters and is considered completed when the ISI for all applicable standards is approximately at the same level while all pass-band ripple, 3 dB, and stop-band requirements are met.
